(19) United States
(12) Patent Application Publication
(10) Pub. No.: US 2012/0269429 A1
(43) Pub. Date: Oct. 25, 2012

(54) APPARATUS AND METHOD FOR SEARCHING IMAGE

(75) Inventors: Joo Young LEE, Daejeon (KR); Youn Hee KIM, Daejeon (KR); Je Ho NAM, Daejeon (KR)

(73) Assignee: Electronics and Telecommunications Research Institute, Daejeon (KR)

(21) Appl. No.: 13/454,908

(22) Filed: Apr. 24, 2012

(30) Foreign Application Priority Data
Apr. 25, 2011 (KR) 10-2011-0038237

(51) Int. Cl. G06K 9/62

(52) U.S. Cl. 382/165

(57) ABSTRACT

Provided is an image search method, including: receiving query image information associated with at least one query image; computing feature information based on color information of the query image information; and retrieving similar image information using feature information of raw image information associated with at least one raw image and feature information of the query image information.

### CROSS-REFERENCE TO RELATED APPLICATION

This application claims the priority benefit of Korean Patent Application No. 10-2011-0038237, filed on Apr. 25, 2011, in the Korean Intellectual Property Office, the disclosure of which is incorporated herein by reference.

### BACKGROUND

1. Field of the Invention

The present invention relates to an image search method and apparatus that may provide an efficient search function during search of captured images to be affected by a change in an illumination and the like.

2. Description of the Related Art

A feature information extracting method used for an image information search method may extract feature information using various sources, and may perform search with respect to image information using the extracted feature information.

For example, the feature information extracting method may extract feature information using a color, a texture, a shape, and the like.

The color is a feature most widely used for an image search, and may be used to extract or compute a feature point associated with a movement, a rotation, a change in a size, a change in an angle, and the like, in image information.

The texture indicates a visual pattern on the surface of an object that may not be reproduced using the color. A search method using a similarity value of texture may extract feature information used to identify images of similar colors.

Shape information may be important to express an object of an image, however, may require relatively great feature extraction costs and may be unsuitable for large capacity search technology.

However, an image search method using a color, a texture, a shape, and the like may not perform image search due to a difference between a raw image and a captured image that may occur due to an image processing algorithm of an illumination or a photographing device, a change in an image photographing environment such as a resolution change, and the like.

Also, the conventional image search method using a color, a texture, a shape, and the like may require relatively great costs for a feature information comparison between a large amount of images and captured images.

Accordingly, there is a desire for an image search method that may provide a further efficient search function during search of a captured image to be affected by a change in an illumination and the like.

### SUMMARY

According to an aspect of the present invention, there is provided an apparatus for storing image feature information, including: an image input unit to receive image information associated with at least one image; an information computing unit to compute feature information based on color information of the image information; and a feature information storage unit to store the feature information.

The image information may include at least one of information associated with a single image and information associated with a plurality of images.

The image information may include at least one of a poster, a book cover, a newspaper advertisement, a magazine advertisement, an album jacket, a logo, and an image constituting a moving picture.

The information computing unit may divide the image information as a matrix including at least one block, obtains color information for each block, and may compute a comparison value of color information of each block with respect to a neighboring block.

The information computing unit may generate the comparison value as a result value of a Boolean scheme.

When the at least one block corresponds to a boundary block, the information computing unit may compute the comparison value by excluding color information associated with an outer block among neighboring blocks.

The color information may include at least one of red, green, blue (RGB) information, a lightness, chrominance, saturation, and hue.

The information computing unit may determine a region of interest (ROI) that is a target region of the feature information based on the image information or a type of a service providing the image information.

The information computing unit may determine the number of the at least one block and a size of the matrix based on the image information or a type of a service providing the image information.

When the comparison value is duplicated, the information computing unit may compute the comparison value by removing a duplicate value.

According to another aspect of the present invention, there is provided an image search apparatus, including: an image input unit to receive query image information associated with at least one query image; an information computing unit to compute feature information based on color information of the query image information; and a similar image search unit to retrieve similar image information using feature information of raw image information associated with at least one raw image and feature information of the query image information.

The image search apparatus may further include an image processing unit to perform at least one of a crop, a rotate, and a sort with respect to the query image information based on a type of the query image information.

The similar image search unit may compute a similarity value between the raw image information and the query image information using a ratio of elements in which feature information of the raw image information and feature information of the query image information have the same value.

The similar image search unit may select information associated with a raw image having a highest similarity value from among the raw image information as the same content or candidate content of the at least one query image information.

The image search apparatus may further include a filtering unit to filter information associated with a raw image to be compared with the query image information in the raw image information associated with the at least one raw image.

According to still another aspect of the present invention, there is provided a method of storing image feature information, including: receiving image information associated with at least one image; computing feature information based on color information of the image information; and storing the feature information.

According to yet another aspect of the present invention, there is provided an image search method, including: receiving query image information associated with at least one query image; computing feature information based on the color information of the query image information; and retrieving similar image information using feature information of raw image information associated with at least one raw image and feature information of the query image information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an imaging apparatus in which an image feature information storage apparatus and an image search apparatus are integrally configured according to an embodiment of the present invention;

FIG. 2 is a flowchart illustrating a method of storing image feature information according to an embodiment of the present invention;

FIG. 3 is a flowchart illustrating an image search method according to an embodiment of the present invention;

FIG. 4 is a diagram illustrating a structure of data of feature information according to to an embodiment of the present invention; and

FIG. 5 is a diagram illustrating a structure of feature information associated with a block A of FIG. 4 according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

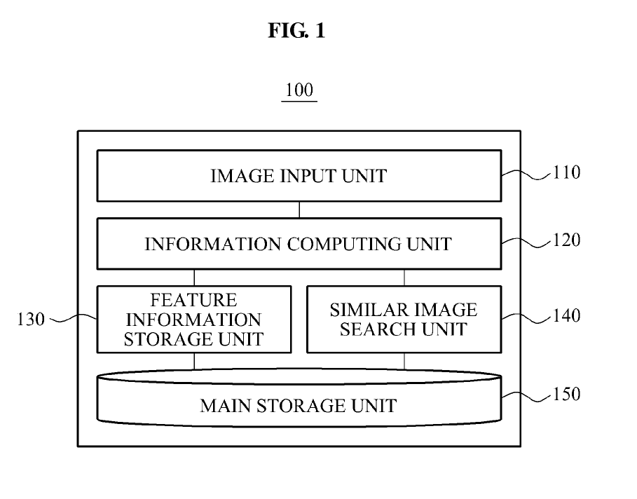

FIG. 1 is a block diagram illustrating a configuration of an imaging apparatus 100 in which an image feature information storage apparatus and an image search apparatus are integrally configured according to an embodiment of the present invention.

Referring to FIG. 1, according to an embodiment of the present invention, the image feature information storage apparatus may include an image input unit 110 to receive image information associated with at least one image, an information computing unit 120 to compute feature information based on color information of the image information, and a feature information storage unit 130 to store the feature information.

According to an embodiment of the present invention, the image search apparatus may include the image input unit 110 to receive raw image information associated with at least one raw image and query image information associated with at least one query, the information computing unit 120 to compute feature information based on color information of the raw image information and color information of the query image information, and a similar image search unit 140 to retrieve similar image information using feature information of the raw image information and feature information of the query image information.

The image search apparatus may further include an image processing unit (not shown) to perform at least one of a crop, a rotation, and a sort with respect to the query image information based on a type of the query image information.

The image search apparatus may further include a filtering unit (not shown) to filter information associated with a raw image to be compared with the query image information in the raw image information associated with the at least one raw image.

The imaging apparatus 100 may store the extracted feature information and similar image information in a main storage unit 150.

Hereinafter, a method of storing image feature information and a method of detecting a candidate image using the imaging apparatus 100 will be described.

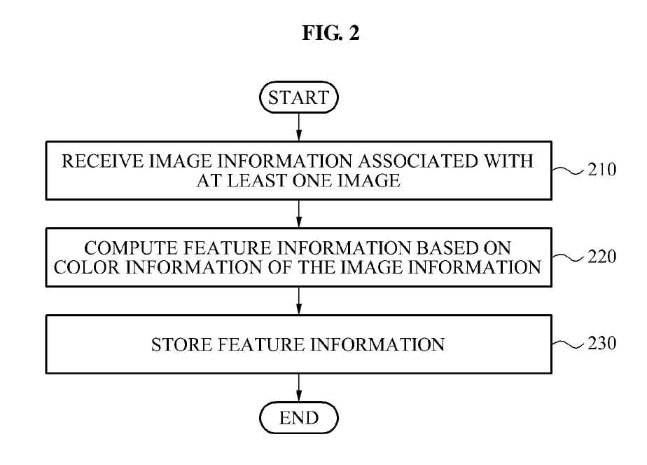

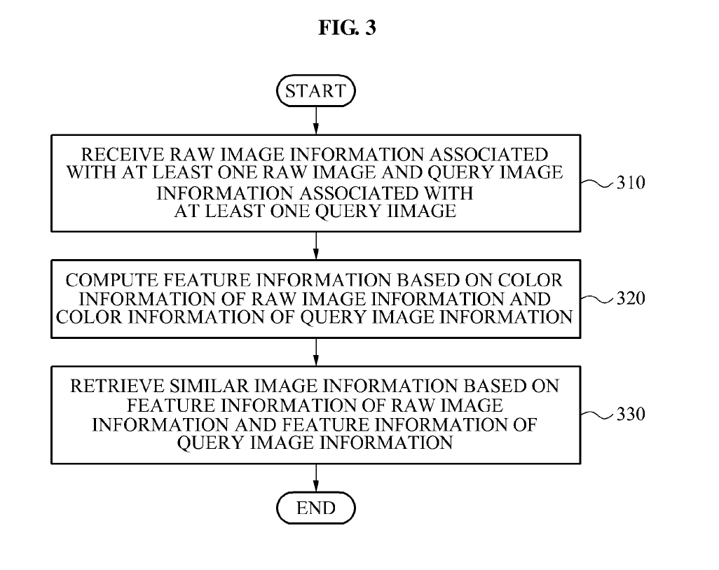

FIG. 2 is a flowchart illustrating a method of storing image feature information according to an embodiment of the present invention, and FIG. 3 is a flowchart illustrating an image search method according to an embodiment of the present invention.

The method of storing image feature information according to an embodiment of the present invention will be described with reference to FIG. 2.

Referring to FIG. 2, in operation 210, the image feature information storage apparatus of FIG. 1 may receive image information associated with at least one image.

The image feature information storage apparatus may receive image information to be stored in a database. For example, the image feature information storage apparatus may receive a single image or a moving picture including a plurality of images.

For example, as image content including a single image, the image feature information storage apparatus may receive various types of image information such as a poster, a book cover, a newspaper advertisement, a magazine advertisement, an album jacket, a logo, an image constituting a moving picture, and the like.

When moving picture content including a plurality of images is received, the image feature information storage apparatus may process each of the plurality of images using the same scheme as a scheme used for the single image.

In operation 220, the image feature information storage apparatus may compute feature information based on color information of the image information.

The information computing unit 120 may divide the image information as a matrix including at least one block, may obtain color information for each block, and may compute a comparison value of color information of each block with respect to a neighboring block.

The information computing unit 120 may generate the comparison value as a result value of a Boolean scheme.

For example, the image information unit 120 may divide raw image information into N×M blocks, may obtain color information for each block, and may compute, using a comparison value of a Boolean scheme, whether a neighboring block of each block has a color value higher than the corresponding block.

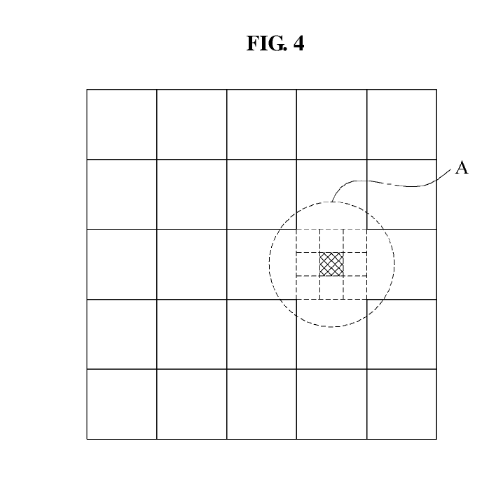

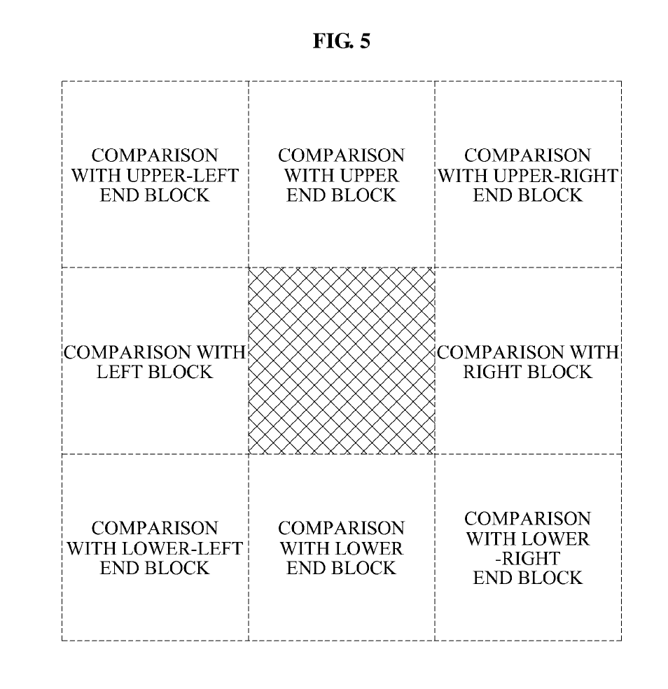

FIG. 4 is a diagram illustrating a structure of data of feature information according to an embodiment of the present invention, and FIG. 5 is a diagram illustrating a structure of feature information associated with a block A of FIG. 4 according to an embodiment of the present invention.

As shown in FIG. 4 and FIG. 5, a single block has eight neighboring blocks and thus, neighboring block information for each block may be expressed as eight Boolean values. When image information includes N×M blocks, (N×M×8) Boolean result values may be used to express the respective color information of the image information.

When the at least one block corresponds to a boundary block, the information computing unit 120 may compute the comparison value by excluding color information associated with an outer block among the neighboring blocks.

The color information may include a variety of information, for example, red, green, and blue (RGB) information, lightness, chrominance, saturation, hue, and the like.

A region of interest (ROI) indicate a target region in which feature information of the input image information is to be extracted, and hue indicates an identifiable characteristic using a name such as red, blue, and green.

Brightness indicates an amount of lightness that indicates lightness of reflector surface of a light source having a predetermined area or light. Chromaticity indicates a property having only two attributes, hue and saturation, out of three attributes of color.

According to an embodiment of the present invention, it is possible to generate feature information associated with respective color information based on Y/Cb/Cr information of image information, and to generate the feature information using R/G/B information.

When using information associated with at least two colors, (N×M×8) Boolean result values may be generated to express the respective feature information. When using Y/Cb/Cr information, it is possible to generate information associated with three features having an (N×M×8) structure.

The information computing unit 120 may determine an ROI that is a target region of the feature information based on the image information or a type of a service providing the image information.

The ROI may indicate a target region in which feature information of image information is to be extracted, and may vary based on the image information or a type of a service.

When there is a sorting issue of input image information and stored raw image information, for example, in the case of photographing and cropping of an image object using a camera, it may be advantageous to use, as an ROI, an inner area excluding a boundary area of an image.

On the contrary, when there is no sorting issue, the entire region of the image may be used as an ROI.

In the case of a service in which regions of input image information and raw image feature information frequently change, for example, in the case of subsequent program information provided in an upper end of an advertisement screen, a portion excluding the corresponding region may be used as an ROI.

The information computing unit 120 may determine the number of the at least one block and a size of the matrix based on the image information or a type of a service providing the image information.

M and N used to determine the number of blocks of the image may vary based on the type of the service.

According to an increase in values of M and N, or according to a decrease in the block size, a more accurate image index may be generated. However, when the increase or the decrease is significant, an amount of operation time may increase.

When there is a sorting issue of input image information and stored raw image information, for example, in the case of photographing and cropping of an image object using a camera, it may not be possible to robustly cope with a change in an angle or a position of image information and a minute change in an illumination.

According to a decrease in values of M and N, or according to an increase in the block size, it may be possible to robustly cope with a change in an angle or a position of image information and a minute change in an illumination. However, in an aspect of search cost, the efficiency may be degraded.

When a comparison value with respect to a neighboring block is duplicated, the information computing unit 120 may compute the comparison value by removing a duplicate value.

Even though eight Boolean result values are required to express an increase or decrease in color information between a predetermined block included in image information and a neighboring block thereof, both blocks may have the increase or decrease in color information. In this case, due to the duplicate same information, the efficiency may be degraded. By decreasing an amount of feature information using a method of removing duplicate of feature information between blocks, it is possible to enhance the efficiency of storage and similarity computation.

In operation 230, the image feature information storage apparatus may store the feature information.

The feature information may be stored in a file form, or may be stored in a blob form of a database with large capacity.

Hereinafter, an image search method according to an embodiment of the present invention will be described with reference to FIG. 3.

Referring to FIG. 3, in operation 310, the image search apparatus of FIG. 1 may receive query image information associated with at least one query image.

The image search apparatus may receive input image information to be searched. Here, image information may include a single image.

For example, as image content including a single image, the image search apparatus may receive various types of image information such as a poster, a book cover, a newspaper advertisement, a magazine advertisement, an album jacket, a logo, an image constituting a moving picture, and the like.

The image search apparatus may perform processing, for example, a crop, a rotate, a sort, and the like, with respect to an image based on input image information.

As one example, when the input image information is an image captured from a display screen, the image search apparatus may crop a screen area in an input operation.

As another example, when capturing an object such as a book cover, a poster, an album jacket, and the like, the image search apparatus may crop an object area in an input operation.

As still another example, the image search apparatus may rotate or sort a captured object in an input operation.

Through processing of the input image information, the image search apparatus may include query image information in the same region as a raw image.

Before receiving query image information, the image search apparatus may process the image information on a side of performing a query request.

In the above case, when the query image information includes the same region as raw image information associated with at least one raw image, the image search apparatus may omit a processing operation with respect to operation 310 of receiving the query image information.

In operation 320, the image search apparatus may compute feature information based on color information of the query image information.

In operation 320, the image search apparatus may compute feature information based on color information of the query image information using the same method as operation 220 and thus, further detailed description will be omitted here.

In operation 330, the similar image search unit 140 of the image search apparatus may retrieve similar image information using feature information of the raw image information and feature information of the query image information.

The similar image search unit 140 may compute a similarity value between the raw image information and the query image information using a ratio of elements in which feature information of the raw image information and feature information of the query image information have the same value.

When using feature information associated with at least two features, the similar image search unit 140 may compute a similarity value of the respective feature information and then compute the total similarity value using a summation or a multiplication of the computed similarity values.

The similar image search unit 140 may sort similarity values between query image information and stored raw image information, and may use the sorted similarity values for image search.

The similar image search unit 140 may select information associated with a raw image having a highest similarity value from among the raw image information as the same content or candidate content of the at least one query image information.

As an example, when using a sorted similarity value for each image, information associated with a raw image having the highest similarity value, or content including the raw image information may be considered as the same content as the query image information. Information associated with a plurality of raw images having the highest similarity value, or content including the raw image information may be considered as candidate content with respect to the query image information.

As another example, when stored content includes information associated with a plurality of raw images such as a moving picture, the similar image search unit 140 may compute a similarity value for each content by employing, as a representative image of corresponding content, information associated with a raw image most similar to the query image information in the raw image information.

The image search apparatus may optimize a similarity computation of query image information.

For example, to decrease costs used for similarity computation between query image information and raw image information, the image search apparatus may selectively perform a filtering operation of an image that is a similarity computation target.

The filtering operation may use feature information associated with at least one feature that is advantageous for simple comparison and data indexing. For example, the average image lightness that may express image feature information as a scalar value, contrast, a discrete cosine transform (DCT) coefficient, the average hue, a relative brightness value with respect to the entire image within a predetermined block of an image, and the like may be used.

According to embodiments of the present invention, there may be provided an image search method that may be robust against a change in an image capturing environment such as an image processing algorithm of an illumination or a photographing device, a resolution change, and the like, and may use low computation costs.

According to embodiments of the present invention, there may be provided an image search method and apparatus that may be robust against a change in a photographing environment and may have low computation complexity when performing image search using a photographing device.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for storing image feature information, comprising:
an image input unit to receive image information associated with at least one image;
an information computing unit to compute feature information based on color information of the image information; and
a feature information storage unit to store the feature information.

2. The apparatus of claim 1, wherein the information computing unit divides the image information as a matrix comprising at least one block, obtains color information for each block, and computes a comparison value of color information of each block with respect to a neighboring block.

3. The apparatus of claim 2, wherein the information computing unit generates the comparison value as a result value of a Boolean scheme.

4. The apparatus of claim 2, wherein when the at least one block corresponds to a boundary block, the information computing unit computes the comparison value by excluding color information associated with an outer block among neighboring blocks.

5. The apparatus of claim 1, wherein the information computing unit determines a region of interest (ROI) that is a target region of the feature information based on the image information or a type of a service providing the image information.

6. The apparatus of claim 2, wherein the information computing unit determines the number of the at least one block and a size of the matrix based on the image information or a type of a service providing the image information.

7. An image search apparatus, comprising:
an image input unit to receive query image information associated with at least one query image;
an information computing unit to compute feature information based on color information of the query image information; and
a similar image search unit to retrieve similar image information using feature information of raw image information associated with at least one raw image and feature information of the query image information.

8. The apparatus of claim 7, wherein the similar image search unit computes a similarity value between the raw image information and the query image information using a ratio of elements in which feature information of the raw image information and feature information of the query image information have the same value.

9. The apparatus of claim 8, wherein the similar image search unit selects information associated with a raw image having a highest similarity value from among the raw image information as the same content or candidate content of the at least one query image information.

10. The apparatus of claim 7, wherein the information computing unit divides the query image information as a matrix comprising at least one block, obtains color information for each block, and computes a comparison value of color information of each block with respect to a block neighboring.

11. The apparatus of claim 10, wherein the information computing unit generates the comparison value as a result value of a Boolean scheme.

12. The apparatus of claim 7, further comprising:
a filtering unit to filter information associated with a raw image to be compared with the query image information in the raw image information associated with the at least one raw image.

13. A method of storing image feature information, comprising:
receiving image information associated with at least one image;
computing feature information based on color information of the image information; and
storing the feature information.

14. The method of claim 13, wherein the computing comprises:
dividing the image information as a matrix comprising at least one block;
obtaining color information for each block; and
computing a comparison value of color information of each block with respect to a neighboring block.

15. The method of claim 12, wherein the comparing comprises generating the comparison value as a result value of a Boolean scheme.

16. An image search method, comprising:
receiving query image information associated with at least one query image;
computing feature information based on the color information of the query image information; and
retrieving similar image information using feature information of raw image information associated with at least one raw image and feature information of the query image information.

17. The method of claim 16, wherein the retrieving comprises computing a similarity value between the raw image information and the query image information using a ratio of elements in which feature information of the raw image information and feature information of the query image information have the same value.

18. The method of claim 16, wherein the retrieving comprises selecting information associated with a raw image having a highest similarity value from among the raw image information as the same content or candidate content of the query image information.

19. The method of claim 16, wherein the computing comprises:
dividing the query image information as a matrix comprising at least one block;
obtaining color information for each block; and
computing a comparison value of color information of each block with respect to a neighboring block.

20. The method of claim 19, wherein the computing the feature information further comprises generating the comparison value as a result value of a Boolean scheme.
